(19) United States
(12) Patent Application Publication
(10) Pub. No.: US 2004/0163773 A1
(43) Pub. Date: Aug. 26, 2004

(54) Stowable composite door system and process

(75) Inventor: Allan D. Murray, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: Ecoplexus Inc., Bloomfield Hills, MI (US)

(21) Appl. No.: 10/371,347

(22) Filed: Feb. 20, 2003

(51) Int. Cl. E06B 9/08

(52) U.S. Cl. 160/133

(57) ABSTRACT

A stowable door system for covering an opening, the door system being characterized by a width (W) and a length (L) in a deployed configuration. The system comprises a plurality of elongate slats having a generally cross section extending parallel to the width (W), the slats having a fiber-reinforced plastic composite with fibers predominantly oriented parallel to the width (W) so that the slats imbue the door with stiffness in the direction of the width (W); hinge sections that connect adjacent slats to provide, in combination with the slats, flexibility in the direction of the length (L); a reel that gathers at least some of the hollow slats and hinges during transition to, or in, a stowed configuration and feeds them during deployment to the deployed configuration; edge guides that support ends of the hollow slats and provide sliding engagement therewith.

### BACKGROUND OF THE INVENTION

1. Field of the Invention

The disclosed invention relates to a stowable door made from a fiber composite, and the process by which it is manufactured. As used herein, the term ‘door’ refers to a stowable device for at least partially covering or exposing an opening. The stowable door's cross-section design and composite material combine to provide a construction that is stiff and able to support or resist high forces or loads that are directed so they have a force component that is orthogonal to the plane of the door when it at least partially covers the opening. The door is also flexible so that it may be rolled or curved for complete or partial removal and stowage.

2. Background Art

It is known to provide roll shutters that are deployed on the inside or outside of building around windows to deter intruders and to provide protection against strong winds and rain. Such devices, however, may be relatively heavy, thereby making their deployment somewhat difficult in some cases. Additionally, several such systems lack stiffness in the plane of their width and height.

Illustrative of the prior art is U.S. Pat. No. 5,964,270. That patent discloses a roll-up type industrial door that includes a flexible vinyl sheet which forms a curtain for closing a doorway. U.S. Pat. No. 6,419,981 discloses products having impregnated glass fiber strands through which the strands are oriented as warp and/or weft strands that are preferably used to form a laminate for a printed circuit board.

### BACKGROUND OF THE INVENTION

There are many types of retractable and roll-up door systems and protective covers available today, including

Roll-up doors made from individual pivotally-connected steel or aluminum slats

Protective screens made from metal mesh or grid links

Flexible fabric coverings that are partially reinforced with battens or wires (U.S. Pat. No. 6,067,911), often after deployment (U.S. Pat. No. 6,286,579) (U.S. Pat. No. 5,655,807)

Wood-slat roll shutters used for many years in Europe

Wood-metal- and plastic-panel garage doors

Tambour door (e.g. roll-top desks, usually wooden or plastic).

These approaches all have deficiencies that are eliminated by the disclosed invention. Metal and wood slat and panel doors are generally strong, but lack damage tolerance. When impacted by a large force directed normal to the slats or panels, metal doors bend or kink permanently such that they no longer deploy properly, while wood and typical plastic doors will break or shatter. Further, doors made by connecting individual panels or slats are expensive to manufacture, and the pivotal connections are a source of weakness and leaks to the door. Wide panels, as used in typical garage doors, reduce the cost by reducing the number of pivotal linkages, but limit the ability of the door to be rolled up. Wood and metal doors are also heavy, requiring expensive and heavy mechanisms and motors for deployment.

Flexible “fabric” doors and coverings lack the ability to support forces normal to the door, thus providing limited protection for enclosed property; and the flexible fabric is subject to tearing. Further, such doors that require inserting stiffeners or battens after the door is deployed (U.S. Pat. No. 6,286,579) (U.S. Pat. No. 5,655,807), are not amenable to automatic deployment.

### SUMMARY OF THE INVENTION

The stowable door system of the subject invention is characterized by a width (W) and a length (L) in a deployed configuration. The system comprises a plurality of elongate slats extending parallel to the width (W), the slats being formed from a fiber-reinforced plastic composite in which the fibers are predominantly oriented parallel to the width (W). The slats imbue the door with stiffness in the direction of the width (W).

Hinge sections connect adjacent slats to provide, in combination with the slats, flexibility in the direction of the length (L). A reel gathers at least some of the hollow slats and hinges during transition to, or in, a stowed configuration and feeds them during deployment to a deployed configuration.

Edge guides support ends of the hollow slats and provide sliding engagement therewith, so that the edge guides, the hollow slats and the hinge sections resist without significant deflection a weight or force exerted at an angle inclined to a plane that includes the width (W) and length (L). The edge guides include a pair of opposing first members that extend generally parallel to the plane that includes the width (W) and length (L) and an end member that connects the pair of opposing first members so that a channel is formed therebetween, within which the slats may be positioned.

Optionally, a sealing member may be disposed at least partially within the channel. It extends from facing surfaces of the opposing first members. The sealing members engage the slats for protection against dust and moisture.

The door system has the additional characteristics of being light in weight and is deployable in an open, concealed, or partially open configuration.

The material used is preferably a fiber-reinforced plastic composite in which the fibers are predominantly oriented in the width direction of the door. The plastic resin may be either thermosetting plastic or thermoplastic. Fibers may be continuous or discontinuous, and be made of glass, carbon, or other reinforcing fiber, or combinations thereof. Because of the fiber orientation, the material has high stiffness (resistance to bending) in the transverse (door width) direction, but relatively less stiffness (more flexibility) in the longitudinal (door length) direction.

The door has stiff, transverse, (preferably) hollow beam elements or slats with approximately rectangular or ‘box’-shaped cross sections, that are connected by hinge sections that permit ready deployment of the slats. The beam elements or slats add to the stiffness and load-carrying capability of the door in the width direction, while the thin hinge sections between the slats permit bending flexibility in the length direction.

One optional process for manufacturing the disclosed stowable door system includes the following steps:

heating a pair of fiber-reinforced thermoplastic composite sheets to a temperature above the plastic melting point of each sheet;

pressing one of the pair of fiber-reinforced plastic composite sheets to form a generally corrugated reinforcement sheet;

orienting one of the pair of sheets atop the other;

applying a force to bond the sheets to one another in a consolidated form; and

cooling the consolidated form to result in an elongate form having hollow transverse structures for withstanding a selected load, and flexible interconnections therebetween.

### BRIEF DESCRIPTION OF THE DRAWINGS

FIG. 1 is a cross-section of a door made by a sheet forming process, looking across the door in the predominant fiber-orientation direction;

FIG. 2 is a cross-section of a door slat made by a pultrusion process.

FIG. 2a depicts a cross-sectional view of two adjacent trapezoidal-section slats that are each attached to a flexible cover sheet;

FIG. 2b illustrates a cross-sectional view of a quadrilateral slat having interlocking hinge members extending therefrom;

FIG. 3 depicts further detail of the door made by a sheet process, illustrating weld and hinge sections;

FIG. 4 is a cross-sectional view of an edge channel and edge detail that provide lateral door support; the section is taken across the width of the door at one edge; the section shown is for a door made by the sheet process, and is similar to a door made by the pultrusion process;

FIG. 4a illustrates a door supported by a full edge of the door;

FIG. 4b depicts a door supported by a shaped return flange; and

FIG. 5 illustrates a stowable door as it is rolled onto a take-up reel; the door can be rolled with the cover (outer surface) being positioned on the inside or outside of the roll; and

FIG. 6 illustrates an integrated process for forming and welding the reinforcement and cover sheets to form the stowable door.

### DETAILED DESCRIPTION OF THE PREFERRED EMBODIMENT(S)

The stowable door system or tambour of the subject invention is characterized by a width (W) and a length (L) in a deployed configuration. The system comprises a plurality of elongate slats extending parallel to the width (W), the slats being formed from a fiber-reinforced plastic composite in which the fibers are predominantly oriented parallel to the width (W). The slats imbue the door with stiffness in the direction of the width (W).

Hinge sections connect adjacent slats to provide, in combination with the slats, flexibility in the direction of the length (L). A reel gathers at least some of the hollow slats and hinges during transition to, or in, a stowed configuration and feeds them during deployment to a deployed configuration.

Edge guides support ends of the hollow slats and provide sliding engagement therewith, so that the edge guides, the hollow slats and the hinge sections resist without significant deflection a weight or force exerted at an angle inclined to a plane that includes the width (W) and length (L). The edge guides include a pair of opposing first members that extend generally parallel to the plane that includes the width (W) and length (L) and an end member that connects the pair of opposing first members so that a channel is formed therebetween, within which the slats may be positioned.

Optionally, a sealing member may be disposed at least partially within the channel. It extends from facing surfaces of the opposing first members. The sealing members engage the slats for protection against dust and moisture.

The door system has the additional characteristics of being light in weight and is deployable in an open, concealed, or partially open configuration.

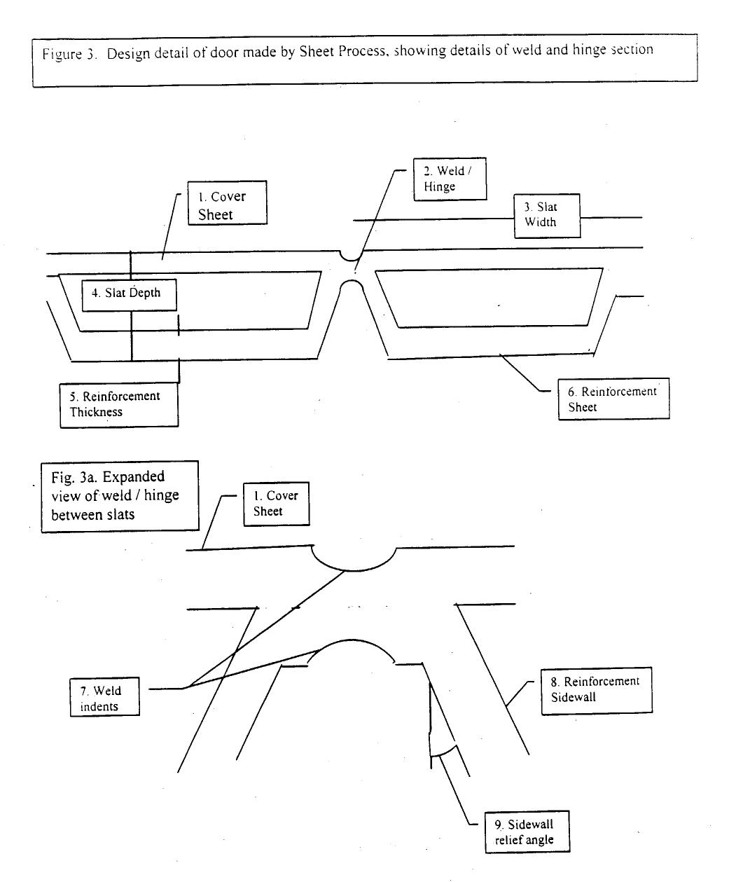

By supporting the door firmly along the sides of the door (FIG. 4a,4b), a substantial weight or force can be supported by the door, even in a partially retracted position. The weight that can be supported will depend on the characteristic strength and stiffness of the composite in the fiber direction, the thickness of the slat walls, and the slat depth (FIGS. 3 and 4), according to classical mechanics. The flexibility of the door in the length direction permits the door to be rolled, or moved in a curved path, to partially or fully uncover the opening.

Applications for such a door include a roll-up garage door, a pickup box cover, a cargo truck door, a removable car roof, a swimming pool cover, storm or vandal protection covers for doors and windows, and the like. The door's primary benefits are its load carrying capability, its light weight, and ability to be stowed or concealed in the fully or partially open position.

Door Material and Process Description:

Generally, there are two main constructions: using individual slats, or forming the slats from continuous sheets, as described below.

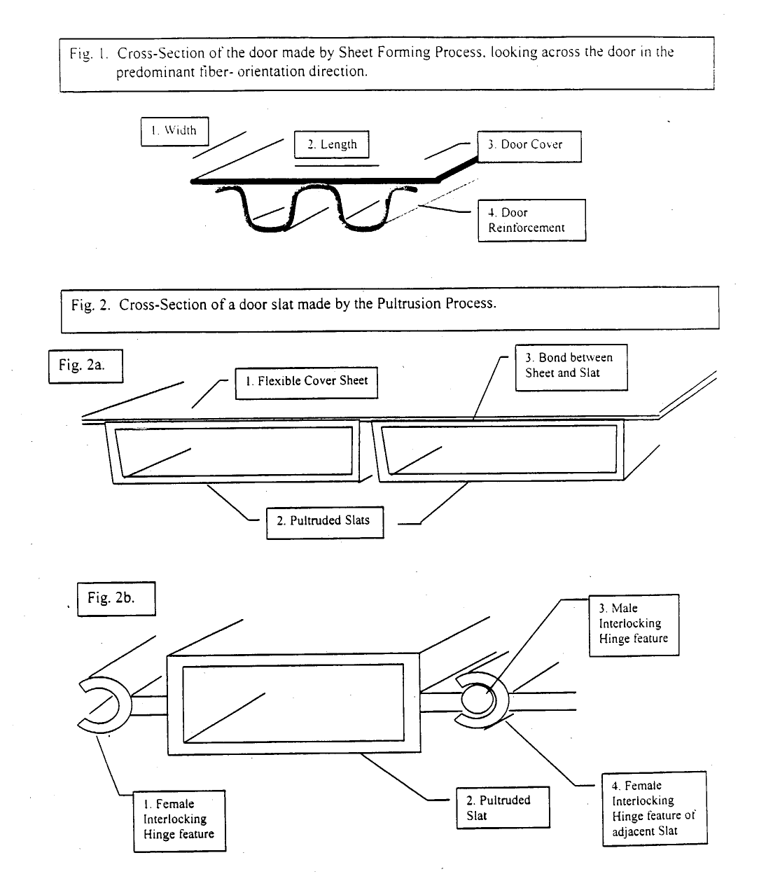

1) Individual Slats—Slats (FIG. 2) are formed by conventional processes such as pultrusion or extrusion, with fiber reinforcement predominantly in the direction of the slats. The slats are connected together by:

a. Bonding them to one side of a flexible cover sheet. The flexible sheet may be any suitable material such as woven fabric, flexible thermoplastic, etc. (see FIG. 2(a)).

b. By means of a ‘male’ interlocking hinge feature attached to one end and a ‘female’ interlocking hinge feature attached at the other. The interlocking hinge sections of several slats are subsequently connected together to form the door (see FIG. 2(b)).

2) Forming the Slats From Continuous Sheets—The door cover sheet (FIG. 1) is made from composite material having fiber reinforcement predominantly across the width of the door, and has a series of ‘hat’ or ‘u’-shaped stiffening channels are attached, such as by bonding or welding, to the back side of the cover across the width of the door. The channels attached to the cover sheet, thus form beam shapes or slats. The channels may be separate elements, but are preferably made from a continuous sheet of the same composite material as the cover sheet, but formed into a corrugated shape. The fiber orientation of these channels is predominantly across the width of the door, in the direction of the channels.

While either of the above processes may be used, the sheet process is preferred because it is expected to have better strength and sealing characteristics and generally lower manufacturing cost. The sheet construction and preferred material and process for the door are further described below.

A starting material for making the door system uses a thermoplastic resin that contains a high volume and weight percentage of aligned fiber reinforcement—preferably 40 weight percent or higher of continuous glass, in the form of a tape. The reinforced plastic ‘tape’ can be made by coating bundles or ‘tows’ of reinforcement fibers, such as glass or carbon fiber, by using a melt-coating process (such as described in by Dykersterhouse in U.S. Pat. No. 5,911,932 which is incorporated by reference), which infuses the thermoplastic resin into the fiber ‘tow’. ('932 patent, FIGS. 4 and 6.) The melt-coated fiber tow is formed into a continuous ‘tape’ of unidirectional-reinforced plastic as it exits hot from the melt-coating device. The tape is then chilled and wound on a spool or creel for subsequent processing into the desired parts. A wide range of width and thickness of tape are possible in such conventional processes. Further variations are disclosed in U.S. Pat. Nos. 5,409,757; 5,296,064 and 5,094,833, which are incorporated by reference.

In the innovative process described herein, the tapes are thin, preferably approximately 0.010″ thick and up to about 10″ wide if desired. A thin tape permits easy handling and rapid heat up to above the melting point of the resin for subsequent operations. The relatively small cross-section dimensions of the tape also assist in the ease of consolidating the tapes into the subsequently formed parts.

It should be noted that many plastic composite fabrication processes combine the fiber wetting and coating step with the shaping or molding step. In the process described herein, these two process steps are beneficially separated to permit optimization and quality control of each process. A key parameter in the performance of composites is the degree of individual filament (fiber) wet-out and resin coating that is obtained. It is a benefit of the disclosed process that this parameter can be optimized in the first step of forming the pre-impregnated tape without compromising the speed or versatility of the molding process.

Once the fiber reinforced thermoplastic tape material has been gathered on spools or creels, a number of the creels can be used to feed material to subsequent forming and consolidation processes. A feature of this process is the versatility of forming processes. Since the resin is thermoplastic, the tape subsequently can be heated above its melting or softening temperature for reshaping and consolidation into the desired composite part. Generally, the material is heated to no more than 200 degrees Fahrenheit above, and preferably, between 20 and 50 degrees Fahrenheit above the thermoplastic resin's melting point.

Sheet Forming Approach:

For making the door cover sheet and the door reinforcement sheet, most of the pre-impregnated tape (preferably 80% or more) is laid down in a direction transverse to the sheet length (that is, in the door transverse direction). A small amount (preferably 20% or less) of tape may be is laid in the sheet length direction and fusion bonded to the transverse tape. The longitudinal fibers help hold the transverse ribbons together for the subsequent consolidation process and provide longitudinal strength to resist cracking from the flexing of the door during roll-up. Preferably, the same thermoplastic resins, or melt-compatible thermoplastic resins are used for both the cover and reinforcement sheets, to permit fusion welding of cover and reinforcement.

After the preform sheet is made, the material is heated to above the melting point of the thermoplastic resin, and compressed to eliminate voids, then cooled to below the melting point to solidify it. A preferable method of compressing the sheet is to use rolls or platens heated to above the melting point to both heat and consolidate the fiber ribbon material, and obtain the desired sheet thickness. After the material has been pressed into a consolidated sheet of the desired thickness, it is then passed through cooling rolls or platens at a temperature below the thermoplastic melting point to solidify it.

The door reinforcement sheet is made the same way and, preferably, of same material as the door cover sheet, but is pressed into its ‘corrugated’ shape while still hot, and then cooled in this configuration. An appropriately shaped ‘corrugation’ roll or platen is used.

The door reinforcement and door outer are then bonded together across the full width of the door along transverse lines of contact. A preferable bonding method is thermal or fusion welding, provided compatible or the same thermoplastic resin is used for both the reinforcement and cover materials. Alternately, adhesive bonding may be used. Fusion welding may be accomplished by pressing a hot tool into the reinforcement surface while the door cover surface is appropriately supported. Welding by other means such as ultrasonic welding is also possible. Preferably, the welding tool surface(s) will be provided with a shallow linear protrusion to form slight indentations or thinning along the full width of the weld and sheet. By thinning the door section at the weld, the slats become easier to flex relative to each other, to permit easier rolling up of the door. The thinned sections become integral hinge lines. The thickness of the hinge line is controlled by welding process to provide adequate door flexibility, without overly weakening the door material.

Fibers incorporated in the longitudinal direction of door help strengthen material against cracking resulting from frequent flexing along the hinge line. This longitudinal reinforcement can be incorporated into the material of the door outer, door reinforcement, or both. Or alternately, it can be a separate thin reinforcement fabric placed between the outer and reinforcement before welding, which becomes joined intimately to the cover and reinforcement during the welding process.

A preferred continuous process for fabricating the door system, which simultaneously forms and weld-joins the cover sheet and reinforcement as illustrated in FIG. 6, is as follows: For both the outer sheet and reinforcement sheet, the steps are:

1) Pre-impregnated fiber tapes cut to the width of the door are laid transversely onto a carrier sheet. Sufficient tapes are laid down per unit length of door so that when melt-consolidated the desired sheet thickness is achieved.

2) The carrier sheet is conveyed into a heater in which the sheet is heated to above the melting temperature of the thermoplastic.

3) The carrier sheet is then conveyed into a press having platens with the desired contour of the outer sheet (flat) or the reinforcement sheet (corrugated). The platens are shaped such that when pressure is applied to the heated thermoplastic composite tapes, the sheet is consolidated and formed into the desired shape and wall thickness. The platens are heated to a temperature somewhat below the thermoplastic melting point (preferably between 50 and 100 degrees Fahrenheit below) so that the thermoplastic quickly solidifies in the platens after consolidating.

4) A force perpendicular to the sheet is applied to the platens to squeeze the material into the desired consolidated shape.

5&6) When the sheet is solidified, the platens are opened and the sheet is conveyed out of the platens. The carrier sheet is then separated and removed from the sheet. In some circumstances, it may be desirable not to remove the carrier sheet so it remains as part of the door. As the formed sheet is conveyed out of the forming platen, a new length of heated tape material is simultaneously conveyed into the platens to be formed. In this way, a sheet of the desired width and length can be formed.

7&8) After the outer and reinforcement sheets are formed as above, they are conveyed into the bonding operation. This may be (preferably) in line and continuous with the forming operation or separate. Here, the inside surfaces of the outer sheet and reinforcement sheet are heated locally to above the melting point of the thermoplastic along transverse lines that will become the hinge lines of the door.

9) After the weld line surfaces are melted, the door reinforcement and outer surfaces are conveyed into the welding platen. They are pressed together to weld and cool the sheet along the weld lines, thus forming the hinges.

10) The door is now formed and can be trimmed to final length and width.

Retaining Features

Retaining features may be formed on the edges of the door (FIGS. 4a,b.) during the process of manufacturing the door, or may be formed in a subsequent forming process by locally heating the cover material and forming it in a suitable tool. This demonstrates another benefit of using thermoplastic resins for the door materials.

Door Edge and Edge Channels

The door sides are retained in edge channels (See FIG. 4) that run the length of the door. The door is designed with means for retaining, such as protrusions or rollers or bearings disposed along the door sides that slide or roll within the edge channels and provide support for the door. In this manner, loads applied to the door are transferred to the edge channels. A return flange may be formed in the protrusion to keep the door from pulling laterally out of the channel. The return flange so formed, would be relieved, or scalloped, at the door hinge lines to not interfere with the flexing of the door during wind-up. As desired for the application, rollers or low friction materials can be incorporated into the channels to allow easier opening and closing of the door.

Also, a means for clamping or locking can be incorporated in the channel to lock the door in a fully or partially closed position. Drains and seals also can be incorporated, for example to channel fluids away from the top of a horizontal door, thus keeping the container watertight.

Sensors

If desired, sensors can be disposed within the edge guides to detect the position of the door. One benefit of such a configuration is that a sensor can detect the position of the door, for example, in a closed configuration. When closed, the sensor may generate a signal to an activator. The activator can then be harnessed in conjunction with such devices as an anti-theft system, or a system wherein the door could be activated remotely.

Slats

Slat width affects the diameter of door wind up that is possible. (See FIG. 3.) The slats must not be so wide that the door does not conform well to the reel as it is being rolled up. A smaller diameter reel permits a smaller cross-section for the rolled-up door. The slat width should preferably be no more than 20% of the desired diameter of the reel.

The diameter of the rolled-up door also increases as the depth of the slats increases. Thus, it is desirable to have the slat depth as small as possible, to permit a smaller cross-section for the rolled-up door. But the slat depth strongly affects the stiffness (resistance to bending) of the slats. Stiffness is approximately proportional to the square of the slat depth. Thus, slat depth must be chosen to balance the requirements of door stiffness and roll diameter. Slat stiffness is approximately linearly proportional to the wall thickness of the slat, and proportional to the elastic (Young's) modulus of the material in the slat direction (door width direction). Thus, it is possible to reduce the slat depth without reducing its stiffness by increasing the slat wall thickness and/or the Young's modulus of the material to compensate.

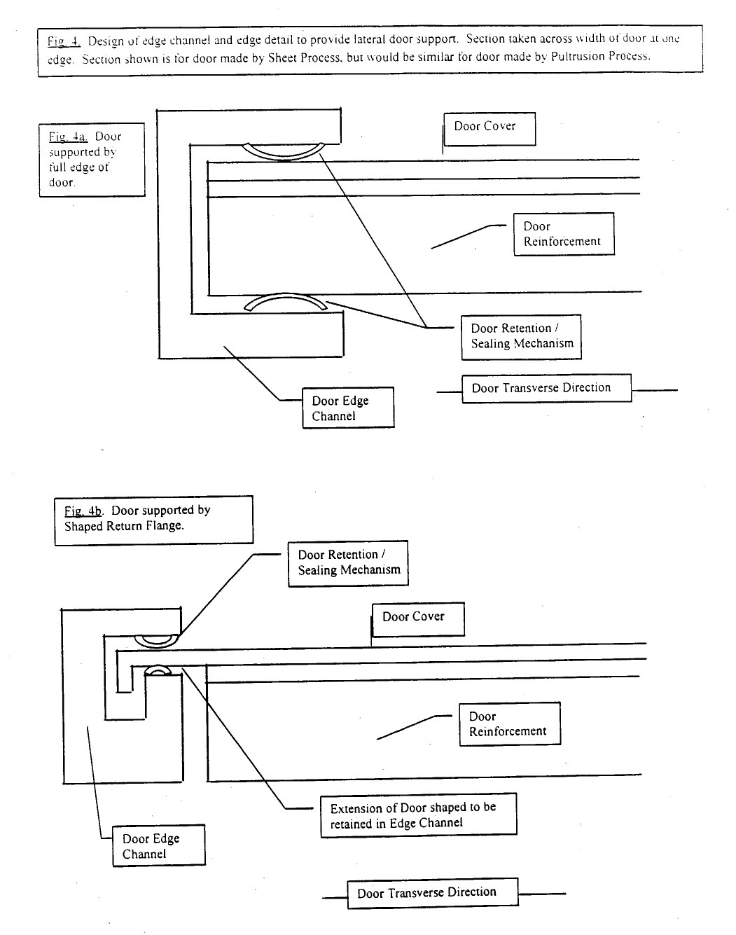

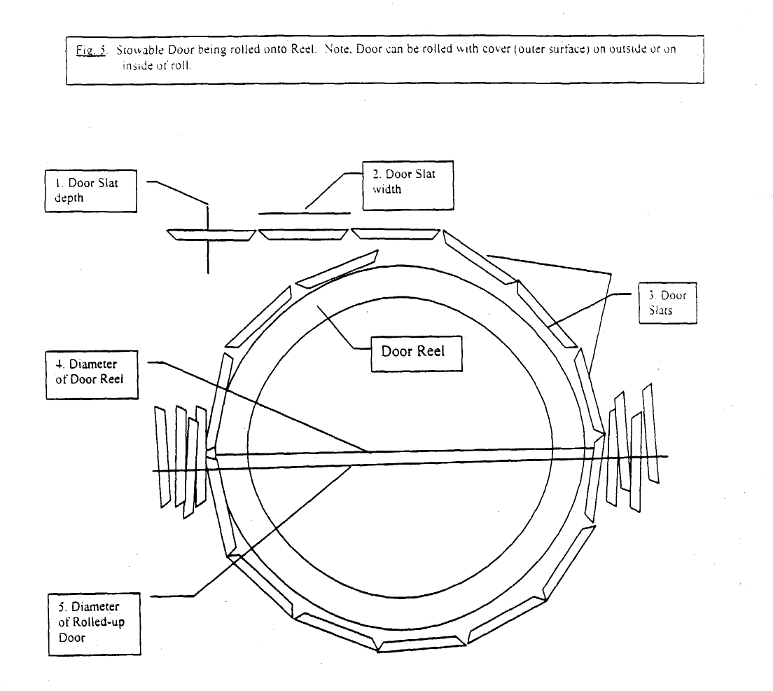

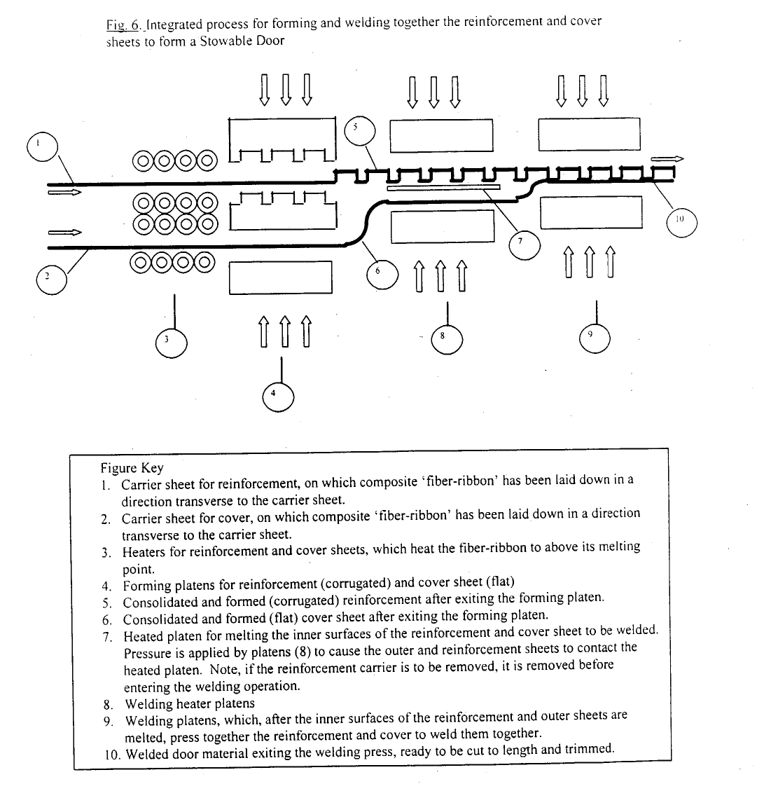

The relief angle of the slat sidewalls must be sufficient to allow the cover to conform to the circumference of the reel as it is being rolled up. This can readily be established by geometric analysis. (See FIGS. 3a and 5.)

It should be appreciated that the term “hollow” as used herein, for example with reference to “hollow slats” includes a cross-section that is either empty, or is at least partially filled with a medium, the medium including but not being limited to foam and the like.

Flexible Coupling Members

In light of the previous disclosure, it can readily be appreciated that multiple sections, each having a length and a width can exist in cooperative engagement. For example, male pins can be deployed within the hollow polygonal sections so that adjacent edges can move in unison. If desired, an interconnecting means could also provide a system whereby adjacent panels are interconnected in a longitudinal direction parallel to the length (L) dimension, as well as the width (W) direction.

Preferably, although not necessarily, gaskets or some other form of sealing material can also be deployed between adjacent edges.

In this manner, multiple sections each having a length and width can be deployed so that they move cooperatively and span, for example, a relatively extensive area for instance, in a garage door opening.

In one embodiment of the invention, the carrier sheet has an outer surface which, optionally, may include decorative indicia to enhance the superficial ornamental appeal of the product made and to enhance the appearance of the door system.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A stowable door system for covering an opening, the door system being characterized by a width (W) and a length (L) in a deployed configuration,
the system comprising:
a panel of a plurality of elongate slats having a generally polygonal cross section extending parallel to the width (W), the slats having a fiber-reinforced composite with at least some of the fibers being oriented parallel to the width (W) so that the slats imbue the door with stiffness in the direction of the width (W) hinge sections that connect adjacent slats to provide, in combination with the slats, flexibility in the direction of the length (L);
a take-up mechanism that accommodates at least some of the slats and hinges during transition to, or in, a stowed configuration and feeds them during deployment to the deployed configuration; and
edge guides that support ends of the slats and provide engagement between the guides and the slats so that the edge guides, the slats and the hinge sections may resist without significant deflection a weight or force exerted at an angle inclined to a plane that includes the width (W) and length (L).

2. The stowable door system of claim 1, wherein the slats comprise a thermoplastic resin.

3. The stowable door system of claim 1, wherein the slats comprise a thermoset material.

4. The stowable door system of claim 1, wherein the slats comprise a material selected from the group consisting of polypropylene, polyethylene, nylon, polyethylene terephthalate, polybutylene terephthalate thermoplastic polyurethane, similar thermoplastics, their copolymers and blends.

5 The stowable door system of claim 1, wherein at least some of the slats are generally trapezoidal in cross-section and are oriented such that the sidewalls of adjacent flats converge when gathered about the reel for compactness in stowage.

6. The stowable door system of claim 1, wherein the plurality of slats each include a first configuration displaced along a first longitudinal end of the slat and a complementary configuration displaced along a second longitudinal end of the slat, the complementary configuration being adapted to interlock with the first configuration such that each slat is interlocked with the sequentially preceding slat and the sequentially following slat.

7. The stowable door system of claim 1, wherein the elongated slats and hinge section comprise longitudinally flexible cover sheet and a transversely corrugated reinforcement sheet that are bonded together.

8. The stowable door system of claim 1, further comprising a sealing member disposed at least partially within the channel extending from facing surfaces of the opposing first members, the sealing members serving to engage the slats for protection against dust and moisture, the door system having the additional characteristics of being light in weight and deployable in an open, concealed, or partially open configuration.

9. The stowable door system of claim 1, further comprising the edge guides including a pair of opposing first members that extend generally parallel to the plane that includes the width (W) and length (L) and an end member that connects the pair of opposing first members so that a channel is formed therebetween within which the slats may be positioned.

10. The stowable door system of claim 8, wherein the corrugated reinforcement sheet defines a series of first peaks that are adjacent to and bonded to the cover sheet and a series of second peaks that are interposed between the first peaks.

11. The stowable door system of claim 8, wherein the cover sheet and the reinforcement sheet are bonded together by fusion welding.

12. The stowable door system of claim 10, further including means for clamping disposed within the edge guide to lock the door system in a fully or partially closed position.

13. The stowable door system of claim 10 further including:
a sensor for detecting the deployment status of the door and/or its lock.

14. The stowable door system of claim 1, wherein each sequential pair of the first series of peaks includes a peak of the second series of peaks and a region of the cover sheet therebetween for collectively defining one of the slats.

15. The stowable door system of claim 7, wherein the bonded portions of the cover sheet and/or the first peaks of the reinforcement each and/or the first peaks have a reduced material thickness to enhance the flexibility and strength of the hinge between adjoining slats.

16. The stowable door system of claim 7, further comprising a pair of transversely corrugated reinforcement sheets, each having adjacent peaks that are bonded together.

17. The stowable door system of claim 7, wherein the bonded portions of the cover sheet and the first peaks include a fiber reinforced material oriented in parallel to the length (L) direction of the door system ribbon to provide the flexible hinge between adjoining slats.

18. The door system of the stowable door system of claim 7, wherein the flexible cover sheet has an outer surface that includes decorative indicia.

19. A process for manufacturing a stowable door system, the method comprising:
heating a pair of fiber-reinforced plastic composite sheets to a temperature above the plastic melting point of each sheet;
pressing one of the pair of fiber-reinforced plastic composite sheets to form a generally corrugated reinforcement sheet;
orienting one of the pair of sheets atop the other;
applying a force to bond the sheets to one another in a consolidated form; and
cooling the consolidated form to result in an elongate form having hollow transverse structures for withstanding a selected load, and flexible interconnections therebetween.

20. The door system of claim 1 including two more panels of elongated slats wherein the panels are connected by interconnection means that operatively connect adjacent edges of the one or more panels so that the one or more panels may move in unison.
